(19) United States
(12) Patent Application Publication
(10) Pub. No.: US 2025/0221328 A1
(43) Pub. Date: Jul. 10, 2025

(54) LIQUID JET SOIL PROCESSING SYSTEMS

(71) Applicant: Hypertherm, Inc., Hanover, NH (US)

(72) Inventors: Matthew Popper, Cayuga (CA); Jeff Martel, Grimsby (CA); Michael Cully, Alpharetta, GA (US)

(21) Appl. No.: 19/015,025

(22) Filed: Jan. 9, 2025

Related U.S. Application Data
(60) Provisional application No. 63/619,152, filed on Jan. 9, 2024.

(51) Int. Cl. A01C 5/06; A01C 7/06; A01C 7/08; A01C 21/00

(52) U.S. Cl. CPC A01C 5/062; A01C 7/06; A01C 7/08; A01C 21/00

(57) ABSTRACT

A nozzle assembly is attached to an agricultural implement comprising a liquid jet soil processing system. The nozzle assembly includes a frame configured to detachably mount to the agricultural implement and a cutting head connected to the frame. The nozzle assembly also includes a secondary nozzle connected to the frame and disposed distal to the cutting head relative to a direction of travel of the nozzle assembly. The nozzle assembly further includes a ground translation device connected to the frame. A tuning unit of the nozzle assembly dynamically connects the cutting head, the secondary nozzle and the ground translation device to the frame. The tuning unit is configured to maintain the cutting head substantially perpendicular to the field surface along a vertical axis as the ground translation device travels across the field.

### CROSS REFERENCE TO RELATED APPLICATION

This application claims the benefit of and priority to U.S. Provisional Patent Application No. 63/619,152 filed on Jan. 9, 2024, the entire content of which is owned by the assignees of the instant application and incorporated herein by reference in its entirety.

### TECHNICAL FIELD

The present invention generally relates to nozzle assemblies for liquid jet soil processing systems.

### BACKGROUND

Traditional methods of large-scale soil conditioning, including seeding and planting, are often ineffective and inefficient when preparing and penetrating hard, compact, or residue-laden soils. Such difficulties become most prominent when trying to plant seeds in fields with heavy residue, stubborn root systems, and/or hardened soil layers, which are conditions often encountered in conservation agriculture or post-harvest scenarios. These unfavorable conditions present considerable obstacles for traditional seeding methods, such as the use of disc openers. For example, these traditional seeding methods are designed to cut through soil and create suitable furrows for seed placement, but they often struggle in harsh conditions, leading to inconsistent furrow depths, improper seed placement, and, consequently, suboptimal germination rates. The disc openers of traditional methods also experience increased wear and tear when dealing with such demanding circumstances, leading to higher maintenance costs and downtime.

Attempts have been made to improve these traditional seeding methods using more durable materials for disc openers and even various mechanical adjustments to disc openers, such as altering the angle or depth of penetration. However, these strategies also fall short, especially in challenging conditions, which can complicate the seeding process. Furthermore, most solutions today neglect a fundamental aspect of the problem in that they attempt to combat the tough in-field conditions by brute force, instead of introducing a different and potentially more effective approach to soil penetration. Some gains have been made with the incorporation of ultra-high pressure liquid jet equipment (e.g., equipment capable of delivering over 5,000 pounds per square inch of liquid jet) into the soil conditioning and planting process. However, ultra-high pressure liquid jet equipment has only been used for industrial cutting solutions (e.g., in the controlled environment of a laboratory, factory, etc.), but not in a dynamic and rapidly changing environment. Its usage in a field on a mobile platform has presented several new challenges, including maintaining proper alignment of multiple components, fluids, and inputs across a dynamic and unpredictable work surface, friction and fire concerns with using a non-wheel type soil interface, and/or in-field maintenance and accessibility issues as wear-and-tear occurs on components during operation.

Therefore, there is a need for agricultural soil processing systems and methods that are more effective and efficient in penetrating hard, compact, or residue-laden soils.

### SUMMARY

The present invention features agricultural soil processing systems and processes (e.g., soil cultivation, fertilizer deposition, seeding processes, etc.) that incorporate a nozzle assembly for adjustably and precisely controlling positions and orientations of delivery of liquid jets during a planting operation. The systems and methods of the present invention provide consistent cut, penetration, and/or deposition performance. Such consistency of liquid flow deposition can provide improved seed spacing accuracy even in challenging terrains.

In one aspect, a nozzle assembly is provided that is attached to an agricultural implement comprising a liquid jet soil processing system. The nozzle assembly includes a frame configured to detachably mount to the agricultural implement, a cutting head connected to the frame, a secondary nozzle connected to the frame, a ground translation device connected to the frame, and a tuning unit dynamically connects the cutting head, the secondary nozzle, and the ground translation device to the frame. The cutting head is configured to introduce a liquid jet received from the liquid jet soil processing system to a field surface below the cutting head. The secondary nozzle is disposed distal to the cutting head relative to a direction of travel of the nozzle assembly. The ground translation device is shaped to physically contact the field as the agricultural implement travels across the field. The tuning unit is configured to maintain the cutting head substantially perpendicular to the field surface along a vertical axis as the ground translation device travels across the field.

In another aspect, a method is provided for seeding a field with a field device comprising a liquid jet soil processing system. The method includes driving the field device over a field. The field device comprises a nozzle assembly detachably connected to an agricultural implement incorporating the liquid jet soil processing system. The method includes compressing unwanted ground surface materials with a ground translation device of the nozzle assembly as the field device traverses across the field and slicing the compressed materials with a jet of liquid delivered by a cutting head of the nozzle assembly to produce a slit through the compressed materials. Slicing of the compressed material by the cutting head may occur at an apex of the ground translation device that is curved in shape. The jet of liquid is pressurized to over 10,000 PSI by the liquid jet soil processing system. The method also includes traversing a rigid soil conditioner of the agricultural implement through the slit and a portion of adjacent soil to shape a seed trench. The method further includes depositing one or more seeds into the seed trench. In some embodiments, the method further includes injecting, by a secondary nozzle of the nozzle assembly, an agricultural input into the slit formed by the cutting head. The injecting of the agricultural input can occur prior to shaping the seed trench by the rigid soil conditioner.

Any of the above aspects can include one or more of the following features. In some embodiments, the agricultural implement, including a rigid soil conditioner, is configured to exert a first downward force on the field along the vertical axis, and the ground translation device of the nozzle assembly is adapted to exert a second downward force on the field along the vertical axis. The first and second downward forces are different. In some embodiments, the first downward force is greater than then second downward force. In some embodiments, the agricultural implement is configured to connect to a mobile device via a linkage system that is dynamically independent, along the vertical axis, from to the frame that links that nozzle assembly to the agricultural implement.

In some embodiments, the tuning unit is configured to enable vertical movement of the cutting head along the vertical axis while inhibiting lateral movement of the cutting head. In some embodiments, the tuning unit comprises a plurality of parallel link arms configured to connect the cutting head, the secondary nozzle and the ground translation device to the frame. The plurality of parallel link arms are configured to promote the vertical movement while inhibiting the lateral movement of the cutting head. In some embodiments, the tuning unit further comprises a precision guide disposed about the cutting head and configured to promote the vertical movement while inhibiting the lateral movement of the cutting head. In some embodiments, the tuning unit is further configured to align the cutting head to a centerline of the nozzle assembly.

In some embodiments, the ground translation device includes a ground contact attachment substantially composed of a non-incendive material. In some embodiments, the ground translation device has a curved shape that is adapted to exert the second downward force to achieve ground compression as the agricultural implement travels across the field. In some embodiments, the nozzle system further includes a detachable post slideably located within a channel of the precision guide. The detachable post is connected to the cutting head to locate the cutting head at an apex of the curved shape of the ground translation device. In some embodiments, the precision guide, via the detachable post, enables the vertical movement of the cutting head along the vertical axis while inhibiting the lateral movement of the cutting head.

In some embodiments, the secondary nozzle is configured to deliver a secondary fluid with a pressure of between about 1000 pounds per square inch (PSI) and 5000 PSI. In some embodiments, at least one of the cutting head or the secondary nozzle is connected to an input system of the liquid jet soil processing system for receiving and injecting at least one agricultural input.

In some embodiments, the nozzle assembly further comprises a brush buster connected to at least one of the tuning unit or the frame. The brush buster is disposed proximal to the cutting head relative to the direction of travel of the nozzle assembly. In some embodiments, the nozzle assembly further comprises a set of high-pressure line connectors configured to connect to respective ones of a set of high-pressure lines from the liquid jet soil processing system to receive the liquid jet. In some embodiments, the nozzle assembly further comprises a ground safety switch configured to activate the cutting nozzle and the secondary nozzle only when a load is detected on the translation device. In some embodiments, the nozzle assembly further comprises a transmission system operably connected to a pump of the liquid jet soil processing system, the transmission system configured to increase the speed of a power unit received from the mobile device.

### BRIEF DESCRIPTION OF THE DRAWINGS

The advantages of the invention described above, together with further advantages, may be better understood by referring to the following description taken in conjunction with the accompanying drawings. The drawings are not necessarily to scale, emphasis instead generally being placed upon illustrating the principles of the invention.

FIG. 1 shows a block diagram of an exemplary field device that includes a liquid jet soil processing system comprising an agricultural implement connected to a nozzle assembly, according to some embodiments of the present invention.

FIG. 2 shows a portion of the field device of FIG. 1, including an exemplary configuration of the nozzle assembly of the field device, according to some embodiments of the present invention.

FIGS. 3a and 3b show a side view and a perspective view of the nozzle assembly of FIG. 2, according to some embodiments of the present invention.

FIG. 4 shows a portion of the nozzle assembly of FIG. 2, including an exemplary configuration of the precision guide of the tuning unit of the nozzle assembly, according to some embodiments of the present invention.

FIG. 5 shows a profile view of a portion of the nozzle assembly of FIG. 2 highlighting the effectiveness of the tuning unit in maintaining perpendicularity of the cutting head and the secondary nozzle relative to the ground surface, according to some embodiments of the present invention.

FIGS. 6a-c show a range of motion of the nozzle assembly 104 as guided by the tuning unit comprising the precision guide and the link arms, according to some embodiments of the present invention.

FIGS. 7a and 7b show various perspective views of a portion of the nozzle assembly of FIG. 2, including an exemplary configuration of the ground translation device of the nozzle assembly, according to some embodiments of the present invention.

FIGS. 8a-c show various configurations of the field device of FIG. 1 incorporating the nozzle assembly of FIGS. 2-3b and one or more row cleaner assemblies, according to some embodiments of the present invention.

FIG. 9 shows a sub-assembly of the nozzle assembly of FIG. 2 comprising the quick-disconnect post and the cutting head of the nozzle assembly that can be easily removed from the nozzle assembly as a single unit, according to some embodiments of the present invention.

FIG. 10 shows a portion of the nozzle assembly of FIG. 2 from which the sub-assembly of FIG. 9 is removed, according to some embodiments of the present invention.

FIGS. 11 and 12 illustrate another approach for quickly removing the cutting head from the nozzle assembly of FIG. 2, according to some embodiments of the present invention.

FIG. 13 shows a detailed view of an exemplary connection of the cutting head to the nozzle assembly prior to its removal using the approach of FIGS. 11 and 12, according to some embodiments of the present invention.

FIGS. 14a-c show a series of steps in an exemplary approach for installing a wear strip onto a bracket of the ground translation device of the nozzle assembly of FIG. 2, according to some embodiments of the present invention.

FIG. 15 shows an exemplary configuration of the field device of FIG. 1 with an additional nozzle located outside of the nozzle assembly of FIGS. 2-3b, according to some embodiments of the present invention.

FIG. 16 shows another exemplary configuration of the field device of FIG. 1 incorporating the nozzle assembly of FIGS. 2-3b, according to some embodiments of the present invention.

FIGS. 17a and 17b show perspective and side views, respectively, of another exemplary configuration of the field device comprising the nozzle assembly of FIGS. 2-3b and the agricultural implement in the form of a traditional mechanical planter, according to some embodiments of the present invention.

FIG. 18 shows a perspective view of yet another exemplary configuration of the field device comprising the nozzle assembly of FIGS. 2-3b connected to the agricultural implement, according to some embodiments of the present invention.

FIG. 19 shows an exemplary process for utilizing the field device of FIG. 1 to seed a field, according to some embodiments of the present invention.

### DETAILED DESCRIPTION

While the embodiments herein are described in the context of soil processing, field seeding and planting, it is understood by a person of ordinary skill in the art that these designs can also be separately and jointly applied to non-seeding agricultural systems and methods, such as to fertilizer application, mineral application, pesticide application, etc. Furthermore, while the soil processing systems of the present invention are described to convey liquid jets, the systems are capable of conveying fluid jets (e.g., liquid jets or gas jets) without alteration of the system configurations, as understood by a person of ordinary skill in the art.

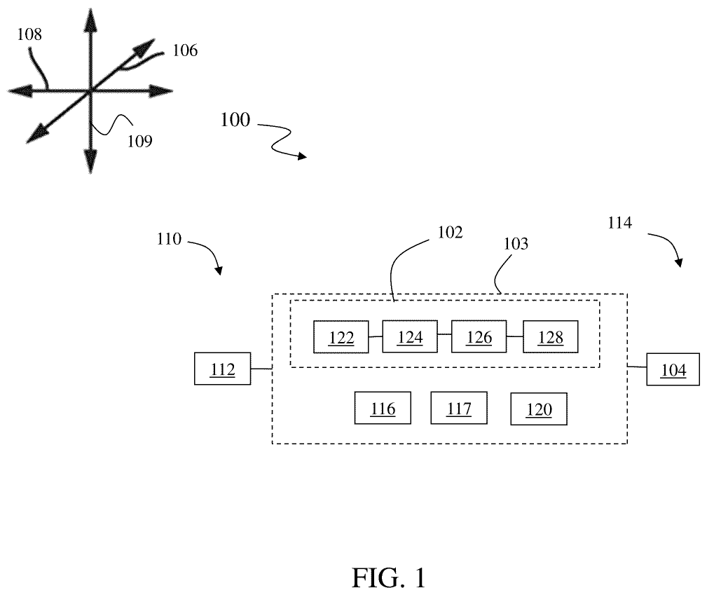

FIG. 1 shows a block diagram of an exemplary field device 100 that includes an agricultural implement 103 connected to a nozzle assembly 104, both of which are translatable across a field by a mobile device 112, according to some embodiments of the present invention. The field device 100 is a three-dimensional structure defining a vertical (z) axis 109, a lateral (y) axis 106, and a longitudinal (x) axis 108 with a distal end 110 and a proximal end 114. The lateral axis 106 and the longitudinal axis 108 span a field to be cultivated, with the longitudinal axis 108 defining the direction of movement of the field device 100 across the field. The mobile unit 112, such as a tractor, is located at the distal end 110 of the field device 100 and configured to move the field device 100 across the field proximally along the longitudinal axis 108.

The nozzle assembly 104 of the field device 100 includes components for cutting through the soil to form a trench and/or depositing one or more agricultural inputs (e.g., pesticide, fertilizer, etc.) into the soil. In some embodiments, the nozzle assembly 104, as described below in detail, includes at least one primary nozzle in the form of an ultra-high-pressure fluid jet cutting head configured to introduce/inject an ultra-high-pressure fluid jet into the field to create a slit in the field, such as in a seed planting process. Optionally, the nozzle assembly 104 includes a secondary nozzle configured to inject at least one secondary fluid, such as a liquid fertilizer, proximate to or into the slit created by the cutting head.

The agricultural implement 103 of the field device 100 includes a liquid jet processing system 102 disposed on a frame, where the liquid jet processing system 102 is configured to generate and supply the ultra-high-pressure liquid jet and/or the agricultural inputs to the nozzle assembly 104 for processing the soil. As shown, the liquid jet processing system 102 includes at least one ultra-high-pressure liquid jet pump 122, one or more optional intensifiers 124, at least one liquid tank 126 and a set of ultra high-pressure lines 128 (e.g., flex hoses or coiled high-pressure lines). The cutting head of the nozzle assembly 104 can be fluidly connected to the pump 122 and the optional intensifier 124 via the set of ultra high-pressure lines 128. The pump 122 and the optional intensifier 124 are configured to draw liquid from the liquid tank 126 and pressurize the drawn liquid to an ultra-high pressure (e.g., over about 5,000 Pounds per Square Inch (PSI), such as over about 10,000 PSI, e.g., about 60,000 PSI) before supplying the ultra-high-pressure liquid to the cutting head of the nozzle assembly 104 via the high-pressure lines 128. In some embodiments, the liquid stored in the liquid tank 126 is water or a mixture of water and an input (e.g., fertilizer, fungicide, etc.). For example, the liquid in the liquid tank 126 can be treated with an additive to prevent fungus growth and/or promote germination. Once received by the cutting head in the nozzle assembly 104, the pressure of the liquid is turned into velocity as the liquid is released through the nozzle of the cutting head at several times the speed of sound. Various embodiments of the ultra-high-pressure liquid jet pump 122, optional intensifiers 124, liquid tank 126 and ultra high-pressure lines 128 are described in U.S. Pat. No. 12,037,766, which is assigned to Hypertherm, Inc. and Susterre Technologies, Inc., and is incorporated herein by reference in its entirety.

Optionally, the agricultural implement 103 can include one or more rigid soil conditioners (e.g., physical opening devices) 116, seeding devices 117 and closing devices 120 attached to the frame of the agricultural implement 103. Each rigid soil conditioner 116 is configured to further shape and/or form a trench from the slit created by the nozzle assembly 104. Each seeding device 117 is configured to seed a trench. Each closing device 120 is configured to close a trench after seed and/or input deposition. Even though the field device 100 is illustrated in FIG. 1 to include the rigid soil conditioner 116, the seeding device 117 and the closing device 120, in alternative embodiments, one or more of these devices 116, 117, 120 are absent or not utilized when, for example, the field device 100 is employed for side-dressing and/or input applications.

In some embodiments, the agricultural implement 103 additionally carries on its frame an input system (not shown) configured to store at least one agricultural input, such as a fertilizer and/or another liquid (e.g., water), for supply to at least one of the cutting head or the secondary nozzle of the nozzle assembly 104. The agricultural implement 103 can also include a pressure regulation system (not shown) for regulating the pressure of an input supply line (not shown) between the input system and the nozzle assembly 104 and preventing contamination of the nozzle assembly 104 and/or the input system. The agricultural implement 103 can further include one or more sources of seeds (not shown) that are accessible by the seeding device 117 for deposition into seed trenches. In addition, the agricultural implement 103 can include at least one hydraulic unit (not shown) for operating one or more of the pumps 122, intensifiers 124, and/or other pressure-generating equipment. The agricultural implement 103 can further include a power unit (not shown) and at least one optional auxiliary power unit (not shown) for powering various field device components, including circuitry in the hydraulic unit. The agricultural implement 103 and/or the mobile device 112 can further include a transmission system (not shown) operably connected to the ultra-high-pressure liquid jet pump 122 and is configured to increase the speed of a drive/power unit received from the mobile device 112. In some embodiments, the agricultural implement 103 and/or the mobile device 112 can further include a step-up gear box (not shown), such as located between the agricultural implement 103 and the mobile device 112, for stepping up and otherwise synchronizing the power take off (PTO) between these two components.

In some embodiments, the step-up gear box receives an input of between about 500 Revolutions Per Minute (hereinafter rpm) to about 1300 rpm, (e.g., between about 540 rpm and 1250 rpm input) and providing an output to the ultra-high-pressure liquid jet pump 122 in the range of between about 1400 rpm and 2200 rpm (e.g., between about 1450 rpm and 2000 rpm). In some embodiments, the step-up gear box receives an input of about 1000 rpm and outputs at about one of 1450 rpm (50 hz electric motor), 1750 rpm or 1800 rpm (60 Hz electric motor) for liquid jet system operation. In some embodiments, the step-up gear box operates with a conversion ratio between about 0.86:1 (1250 rpm input and 1450 rpm output) and about 0.27:1 (540 rpm input and 2000 rpm output). In some embodiments the input received by the step-up gear box is converted to an output rpm (about 1750 rpm to about 1800 rpm) that is complementary/matched to a 60 Hz electric motor rpm which matches that of industrial pumps, thereby causing the liquid jet pump/system side to see that input rpm from the electric motor. In one embodiment, a 12 row planting system includes a step-up gearbox that takes a 1000 rpm input and provides a 1700 rpm output (e.g., about 0.588:1).

In some embodiments, the agricultural implement 103 further includes a hydraulic cylinder driving system (not shown) configured to apply a positive hydraulic pressure on the ground for the purpose of preventing excessive bouncing of the field device 100 as it travels. Various embodiments of the input system, pressure regulation system, hydraulic unit, power unit, optional auxiliary power unit, transmission system, as well as any possible additional components of the agricultural implement 103 and/or the mobile device 112 are described in U.S. Pat. No. 12,037,766, which is assigned to Hypertherm, Inc. and Susterre Technologies, Inc., and is incorporated herein by reference in its entirety.

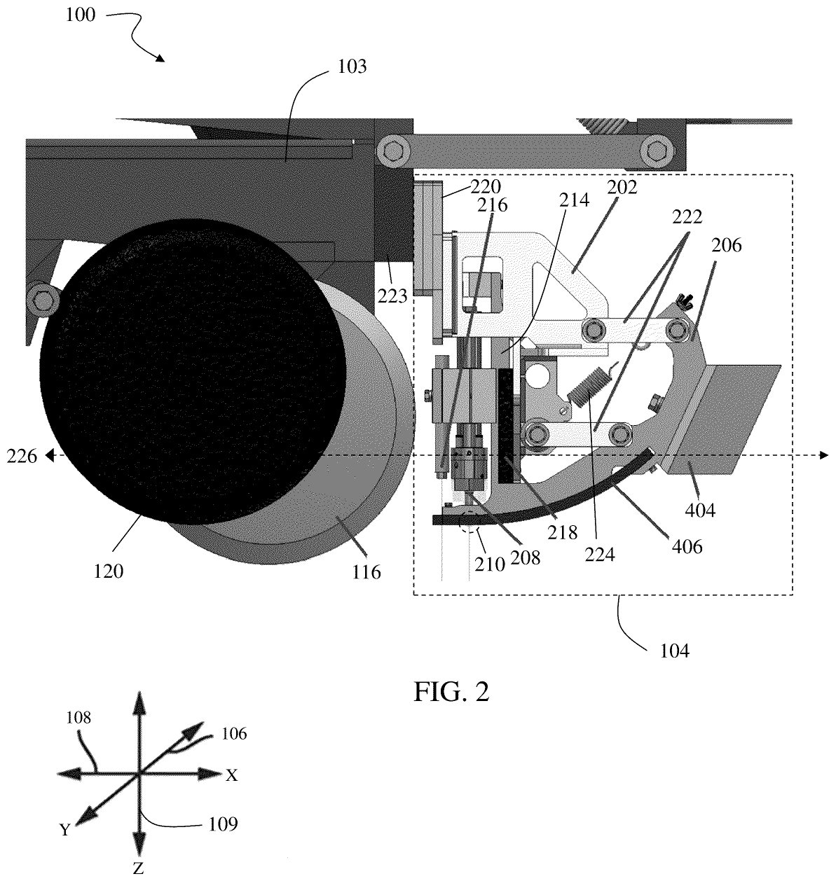

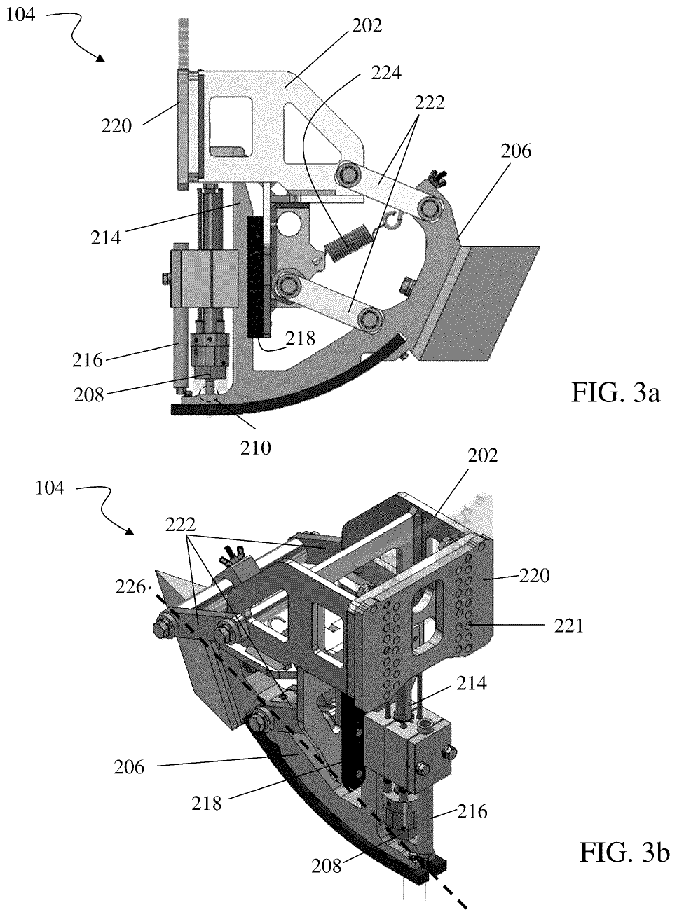

FIG. 2 shows a portion of the field device 100 of FIG. 1, including an exemplary configuration of the nozzle assembly 104 of the field device 100, according to some embodiments of the present invention. FIGS. 3a and 3b show a side view and a perspective view of the nozzle assembly 104 of FIG. 2, according to some embodiments of the present invention. As shown in FIG. 2, the nozzle assembly 104 is removably attached to the agricultural implement 103, which includes the rigid soil conditioner 116 (e.g., a disc opener) and the closing device 120. In particular, the nozzle assembly 104 can be positioned in advance of both the rigid soil conditioner 116 and the closing device 120 along the longitudinal axis 108. During operation, the nozzle assembly 104 is adapted to process the field before the rigid soil conditioner 116, which in turn is adapted to process the field before the closing device 120. However, in alternative embodiments, one or more of the rigid soil conditioner 116 and the closing device 120 is absent or not utilized, such as when the field device 100 is employed for side-dressing and/or input applications.

The nozzle assembly 104 generally includes an ultra-high pressure cutting head 208 and optionally, a secondary nozzle 216. In some embodiments, the secondary nozzle 216 and the cutting head 208 are located on a centerline 226 of the nozzle assembly 104, where the centerline 226 is defined as extending substantially through the center of the nozzle assembly 104 along the longitudinal axis 108 (as clearly illustrated in FIG. 3b). In some embodiments, the centerline 226 of the nozzle assembly 104 also extends through the rigid soil conditioner 116 (e.g., a disc opener) to maintain alignment between the rigid soil conditioner 116 and the nozzle assembly 104, thereby ensuring alignment between the cut slit generated by the nozzle assembly 104 and the path of the rigid soil conditioner 116 to improve planting accuracy and efficiency. In some embodiments, the secondary nozzle 216 is disposed between the rigid soil conditioner 116 and the cutting head 208 along the centerline 226 (e.g., proximal to/in front of the rigid soil conditioner 116 and distal to/behind the cutting head 208). In some embodiments, the closing device 120 is offset from the centerline 226 and is distal relative to the rigid soil conditioner 116, such that the closing device 120 is in a staggered arrangement relative to the rigid soil conditioner 116.

The nozzle assembly 104 of FIG. 2, when attached to the agricultural implement 103, generally enables proper alignment and spacing of the high-pressure fluid jet system with the seed planting device to enhance operational efficiency. For example, during a seed planting process, after the nozzle assembly 104 forms a slit in the ground via the cutting head 208 and optionally deposits a secondary fluid into the slit via the secondary nozzle 216, the rigid soil conditioner 116 can create a seeding trench from the slit, within which the seeding device 117 (not shown in FIG. 2) can deposit one or more seeds. In some embodiments, the secondary nozzle 216 is configured to apply the secondary fluid after slit formation and prior to seed injection. The closing device 120 can then collapse soil on top of the seeded trench. Using the cutting head 208 to create the slit in the soil before the application of the rigid soil conditioner 116 can reduce the mechanical effort required by the rigid soil conditioner 116 to form a trench and accelerate the planting process. The resulting precise slit(s) created using the high-pressure fluid jet is adapted to reach a clean and uniform depth for the seeds, thereby improving seed placement by the seeding device 117 and promoting germination and growth rates, ultimately resulting in increased crop yield. Moreover, the secondary nozzle 216 of the nozzle assembly 104 enables the application of fertilizers or other inputs directly into and/or proximate to the slit created by the cutting head 208 to ensure that the fertilizer is placed close to the seed, thereby maximizing effectiveness and minimizing waste.

As shown in FIGS. 2-3b, the nozzle assembly 104 includes a relatively rigid frame 202 configured to detachably mount the nozzle assembly 104 to the agricultural implement 103. This detachable mounting can be achieved by attaching an interface 220 of the frame 202 to a stone guard 223 on the agricultural implement 103. In an exemplary configuration, as shown in FIG. 3b, the interface 220 can include multiple rows of bolt holes 221 spaced vertically (along the vertical axis 109) to permit a range of height adjustability, such as in 0.5-inch increments, when attaching the nozzle assembly 104 to the agricultural implement 103. Such adjustability accommodates different agricultural needs, conditions, seed requirements, etc. In some embodiments, the interface 220 is designed to retrofit the nozzle assembly 104 to any existing agricultural implement 103, such as a planter for side-dressing, a tool bar for input applications and/or other cutting implements. In general, the nozzle assembly 104 can be a retrofit unit conveniently connectable to any existing seeding/planting device via the frame 202.

In some embodiments, after the nozzle assembly 104 is attached to the agricultural implement 103 via interface 220, the downward force (along the vertical axis 109) exerted by the nozzle assembly 104 on the ground to be cultivated, such as via a ground translation device 206 of the nozzle assembly 104, is considerably smaller than that exerted by the agricultural implement 103 via its ground-contacting element (e.g., the rigid soil conditioner 116). Details about the ground translation device 206 are provided below. Because of these two distinct downward forces, the force exerted by the nozzle assembly 104 does not interfere with the critical relationship between the rigid soil conditioner 116 of the agricultural implement 103 and the ground, which sets the disc cutting depth and ultimately the seed planting depth. In some embodiments, the downward force of the nozzle assembly 104 when in contact with the ground is substantially negligible when compared to the downward force applied by the agricultural implement 103. For example, the downward force of the nozzle assembly 104 can be in the scale of tens of pounds and is independent of the downward force of the agricultural implement 103 which is routinely in the scale of hundreds of pounds. Therefore, the downward vertical force exerted by the nozzle assembly 104, which can be substantially along the z-axis 109, is independent of the downward vertical force exerted by the agricultural implement 103 along the z-axis 109. Such relative independence between the nozzle assembly 104 and the agricultural implement 103 can prevent jamming of the ground translation device 206 of the nozzle assembly 104 as it translates across the field with much less contact force, allowing residue to “flow” easier under it as compared to configurations where the entire field device operates as a single unit (e.g., with a single parallel linkage) that involves the agricultural implement 103 having a downward force shared with the nozzle assembly 104. In some embodiments, the nozzle assembly 104 has a spring-based configuration to enable such independence. Alternatively, the nozzle assembly 104 has a pneumatic and/or hydraulic configuration associated with a monitoring/control system for supplying and adjusting appropriate downward force applied by the nozzle assembly 104 on the ground.

As explained above, the frame 202 connects/links the nozzle assembly 104 to the agricultural implement 103 at the proximal end 114 of the field device 100. In some embodiments, a linkage system (not shown) connects the mobile device 112 (e.g., a tractor) to the agricultural implement 103 at the distal end 110 of the field device 100. The linkage system at the distal end 110 and the frame 202 at the proximal end 114 can operate dynamically independent of each other along the vertical axis 109.

Referring to FIGS. 2-3b, in an exemplary configuration of the nozzle assembly 104, the frame 202 is connected to the ground translation device 206 that has a curved bottom surface configured to physically contact a field to be cultivated as the field device 100 traverses across the field. In some embodiments, the ground translation device 206 is also substantially disposed along the centerline 226 of the nozzle assembly 104 proximal to the cutting head 208 and the secondary nozzle 216. In some embodiments, the ultra-high-pressure fluid jet cutting head 208 of the nozzle assembly 104 is connected between the frame 202 and the ground translation device 206 and is configured to introduce, along the vertical axis 109, a liquid jet to the field directly below the cutting head 208. For example, the cutting head 208 can operate at about 10,000 PSI or higher (e.g., 60,000 PSI) to cut through unwanted ground surface materials and penetrate the ground surface to generate a slit. Hereinafter, “unwanted ground surface materials” are defined as residues (e.g., organic matter, rock, glass, steel, etc.), stubbles, covered crops, soil and/or roots, etc., either dead or alive, either anchored to the ground or loose and disposed between the soil and the agricultural implement 103 and/or nozzle assembly 104. In some embodiments, the cutting head 208 is vertically aligned (along the vertical axis 109) with the apex 210 of the curved surface of the ground translation device 206. Alignment of the cutting head 208 with the apex 210 ensures maximum contact of the liquid jet delivered by the cutting head 208 with the ground directly beneath it, thereby maximizing the cutting effectiveness of the cutting head 208. In addition, such placement of the cutting head 208 relative to the apex 210 assists in causing the unwanted ground surface material that has flown under the curved surface of the ground translation device 206 to this point to compress between the ground translation device 206 and the ground, thereby reducing the air volume in the unwanted ground surface material to enhance the liquid jet's ability to cut through the material.

In some embodiments, the cutting head 208 is attached to the ground translation device 206 via a detachable post 214, such as in the form of a vertical quick-disconnect post, connected therebetween. In some embodiments, the detachable post 214 situates the cutting head 208 to substantially align with the apex 210 of the ground translation device 206 along the vertical axis 109. In some embodiments, the detachable post 214 allows the cutting head 208 to move up and down vertically with the ground translation device 206 while adapting to ground variations. In some embodiments, a quick-disconnect feature of the post 214 enables easy removal of the cutting head 208 to facilitate, for example, cutting head servicing in a more convenient location and/or on a periodic basis. Even though the quick-connect post 214 is shown to be integrally formed with the ground translation device 206, in alternative embodiments, the quick-connect post 214 can be a separate/distinct element of the nozzle assembly 104.

In some embodiments, the secondary nozzle 216 of the nozzle assembly 104 is connected to the frame 202 and configured to inject at least one secondary fluid into the slit created by the cutting head 208. The secondary fluid can be an input such as a liquid fertilizer and/or unrelated to seeding. The secondary nozzle 216 can be positioned vertically along the vertical axis 109 such that secondary fluid reaches a depth of about four inches below the ground surface. The nozzle exit orifice of the secondary nozzle 216 can be above or below soil level. In some embodiments, the secondary nozzle 216 has an orifice diameter ranging from about 0.020 inches to about 0.050 inches and operates at a pressure between about 20 PSI to about 10,000 PSI, such as between about 1,000 PSI and about 5,000 PSI, in which case the secondary nozzle 216 permits the injection of fertilizers or other fluid substances into the slit that cannot be processed through the ultra-high-pressure pump 122 or when a higher quantity is needed. This precise injection via the secondary nozzle 216 thus helps ensure optimal seed growth conditions immediately after planting. Alternatively, the secondary nozzle 216 can be an ultra-high-pressure nozzle capable of delivering an input at, for example, about 60,000 PSI or higher.

In some embodiments, the nozzle assembly 104 includes a set of high-pressure line connectors (not shown) configured to connect to respective ones of the set of high-pressure lines 128 from the liquid jet soil processing system 102. These high-pressure line connectors are configured to receive a flow of the ultra-high-pressure liquid from the liquid jet soil processing system 102 for delivery by at least one of the cutting head 208 or the secondary nozzle 216. In addition, at least one of the cutting head 208 or the secondary nozzle 216 may be fluidly connected to the input system of the agricultural implement 103 described above to receive and dispense one or more agricultural inputs to the soil.

In some embodiment, the nozzle assembly 104 includes a tuning unit dynamically connecting the cutting head 208, the secondary nozzle 216 and the ground translation device 206 to the frame 202. During travel, the tuning unit is configured to maintain alignment of these components along the centerline 226 of the nozzle assembly 104 (i.e., minimize their lateral deviations/side-to-side movements along the lateral axis 106) while permitting them to move vertically in response to variations in ground terrain. This ensures consistent field performance regardless of landscape. This can also ensure that during operation the slit generated by the cutting head 208 is in alignment with the path of the rigid soil conditioner 116 for creating a trench from the slit, thereby improving planting accuracy and efficiency. In an exemplary configuration, the tuning unit can include multiple parallel link arms 222 connecting the ground translation device 206 to the frame 202 to ensure that the ground translation device 206 maintains perpendicularity in movement to the ground (i.e., along vertical axis 109) regardless of how uneven the ground is. The tuning unit can also include a precision guide 218 connecting the cutting head 208 to the frame 202 to ensure that the cutting head 208 is oriented substantially perpendicular to the ground surface (i.e., along vertical axis 109) across varied terrains. In general, the vertical precision guide 218, in combination with the link arms 222, can interconnect the cutting head 208, the secondary nozzle 216, the ground translation device 206 and the frame 202. In some embodiments, the tuning unit includes a shock absorber 224, such as a spring connected between the ground translation device 206 and the precision guide 218, to dampen and/or eliminate chatter of the ground translation device 206 that may disrupt ground contact. In some embodiments, the shock absorber 224 is a passive system. Alternatively, the shock absorber 224 can be an active sensor-based system. Details regarding the various components of the nozzle assembly 104 are provided below.

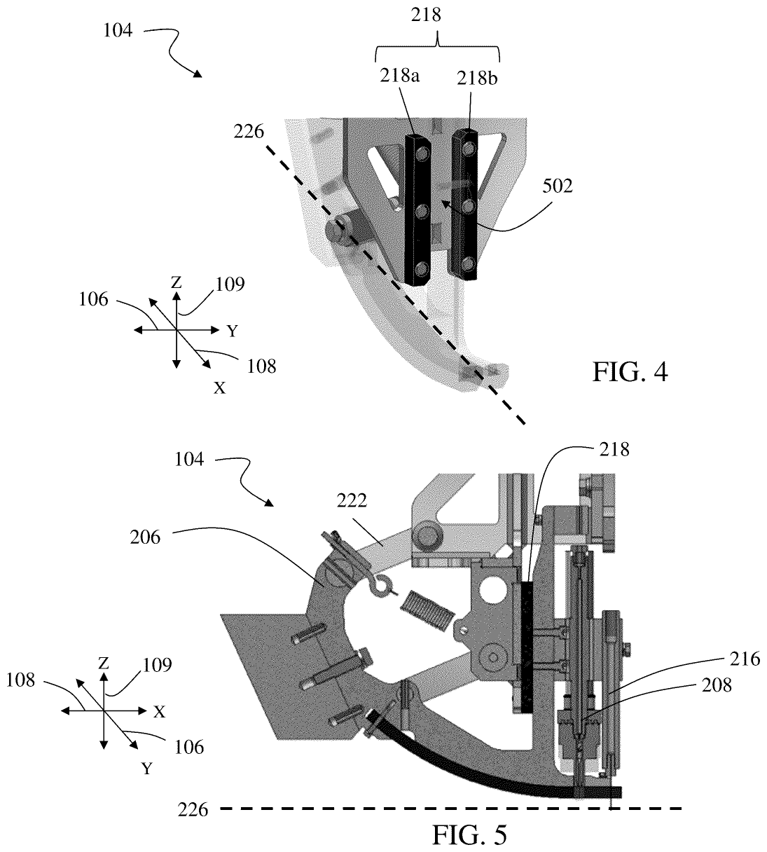

FIG. 4 shows a portion of the nozzle assembly 104 of FIG. 2, including an exemplary configuration of the precision guide 218 of the tuning unit of the nozzle assembly 104, according to some embodiments of the present invention. FIG. 5 shows a profile view of a portion of the nozzle assembly 104 of FIG. 2 highlighting the effectiveness of the tuning unit in maintaining perpendicularity of the cutting head 208 and the secondary nozzle 216 relative to the ground surface, according to some embodiments of the present invention.

As shown in FIG. 4, the precision guide 218 has two substantially vertical bodies 218a, 218b spaced laterally apart (along lateral axis 106) to define a guide channel 502 located across the centerline 226 of the nozzle assembly 104. The guide channel 502 is configured to guide the movement of the cutting head 208 (and optionally, the secondary nozzle 216) by laterally sandwiching it between the precision guide bodies 218a, 218b. In particular, the cutting head 208 is bolted to the vertical quick-disconnect post 214, which is located in the guide channel 502 created by the precision guide 218 and is adapted to slide vertically within the guide channel 502, while being constrained laterally by the precision guide bodies 218a, 218b. Such a construction is adapted to prevent sideway/lateral movement of the cutting head 208 and/or secondary nozzle 216 (connected to the vertical post 214) during operation while permitting up-and-down/vertical movement of the cutting head 208 and/or secondary nozzle 216 along the vertical axis 109 for vertically adjusting/responding to any undulations of the soil. In addition, since multiple components are connected to the cutting head 208 and/or secondary nozzle 216 via the link arms 222 and the frame 202, the guide channel 502 also serves as an anchor for alignment of these components to the centerline 226 of the nozzle assembly 104 to prevent lateral deviations from the centerline 226. More specifically, the link arms 222 and the frame 202 are adapted to connect multiple components of the nozzle assembly 104 in a vertical stack-up where the components are spaced and secured relative one another. In turn, the vertical stack-up can be aligned along the centerline 226 of the nozzle assembly 104 via guidance by the precision guide 218. These components of nozzle assembly 104 can include the ground translation device 206, the cutting head 208, the secondary nozzle 216, and any associated tubing (not shown) for supplying fluids to the cutting head 208 and/or the secondary nozzle 216. Such a configuration ensures that these components move substantially uniformly as a single unit vertically along the channel 502 (along vertical axis 109) as the field device 100 navigates through various undulations in the field caused by soil differences and/or unwanted ground surface materials during operation. Furthermore, such a configuration prevents these components from separating relative to one another, sliding side-to-side to deviate from the centerline 226, and/or misalign relative to the rigid soil conditioner (e.g., disc opener) 116.

As described above, the tuning unit of the nozzle assembly 104 includes multiple link arms 222 that assist the precision guide 218 in facilitating vertical movement of multiple components in the nozzle assembly 104 while maintaining their perpendicularity relative to the ground surface regardless of terrain conditions. In some embodiments, the frame 202 provides the foundation for a set of four parallel link arms 222 that are evenly distributed and connected to either side of the ground translation device 206. For example, as clearly illustrated in FIG. 3b, the tuning unit includes four link arms 222 with two link arms 222 disposed on either side of the ground translation device 206. Two upper link arms 222 can directly connect the ground translation device 206 to the frame 222. Two lower link arms 222 can connect the ground translation device 206 to the precision guide 218, which in turn anchors to the cutting head 208 and the secondary nozzle 216. Therefore, the link arms 222, in cooperation with the precision guide 218, connect multiple components in the nozzle assembly 104 to the frame 202, including the ground translation device 206, the cutting head 208, the secondary nozzle 216 and/or the fluid tubing, enabling them to move as a singular unit.

Overall, the tuning unit, including the link arms 222 and the precision guide 218, keeps components of the nozzle assembly 104 aligned and properly spaced with one another along the centerline 226, while permitting substantially uniform movement of these components in the vertical axis 109 (e.g., bounce up and down) and limiting movement of these components along the lateral axis 106 (e.g., side-to-side swaying motion). As the field device 100 travels across the field in the longitudinal direction 108, such limited and appropriately spaced mobility of the nozzle assembly 104 in the vertical direction 109 allows the field device 100 to accommodate ground surface and residue irregularities to retain proper spacing and distance from row and trench depth for seeding, while avoiding alignment issues with components and/or other rows being planted. As shown in FIG. 5, the link arms 222 and the precision guide 218 of the tuning unit of the nozzle assembly 104 are connected to both the cutting head 208 and the secondary nozzle 216 to stabilize their fluid delivery through the ground translation device 206. The tuning unit provides proper spacing and alignment of the cutting head 208 and the secondary nozzle 216 with the vertical axis 109 such that these nozzles can inject fluids into the ground in a substantially vertical direction, while accommodating displacements dictated by the ground surface, substantially maintaining a consistent spacing between the tips of the cutting head 208 and secondary nozzle 216 relative to the soil surface. In addition, the tuning unit permits relative spacing and alignment of these components with the longitudinal axis 108 along the centerline 226 of the nozzle assembly 104 to ensure proper overlap of the processing paths of the nozzles.

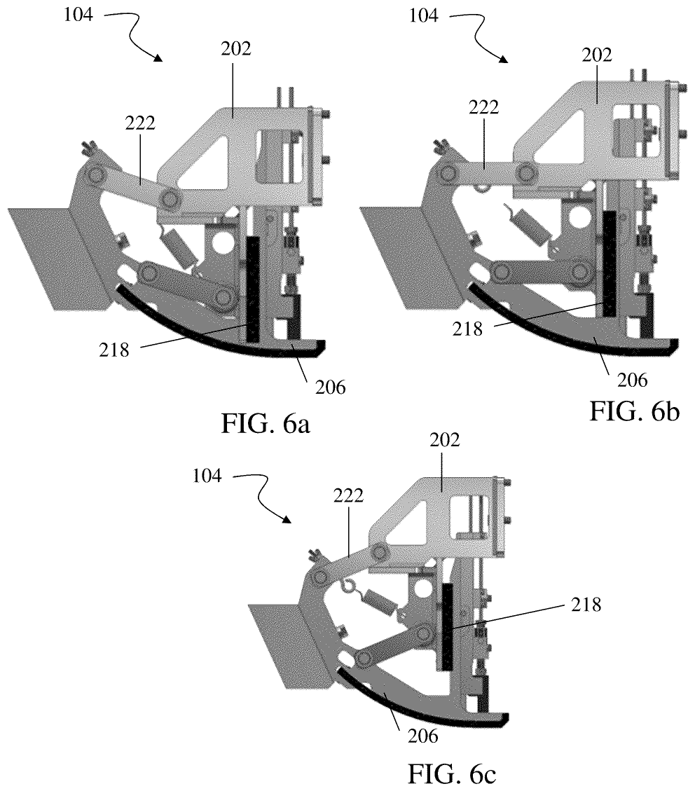

FIGS. 6a-c show a range of motion of the nozzle assembly 104 as guided by the tuning unit comprising the precision guide 218 and the link arms 222, according to some embodiments of the present invention. As the field device 100 travels across a field, various components of the nozzle assembly 104 can move in unison in a series of vertical displacements. In FIGS. 6a-c the range of motion of the field device 100 and nozzle assembly 104 is shown between an extended down position with the ski/translation device 206 stretching down to contact the ground/surface, in a flat/steady state loaded condition, and an in an extreme up condition where the ground surface is close to the frame 202, these are discernible and can be seen by comparison of the parallel linkage bars/arms 222 and relative vertical position of the nozzle assembly 104 relative to the frame 202.

In FIG. 6a, the frame 202 is comparatively close to the ground with back pressure pushing the ski/translation device 206 and nozzle assembly 104 up towards frame 202 as indicated by the upward angle of the linkage bars/arms 222 and the top of the nozzle assembly 104 extending into a topmost portion of the frame 202, indicating that the nozzle assembly 104 is at about the top point of its allowable vertical range of motion within the field device 100. In FIG. 6b, the substantially level parallel linkage bars/arms 222 connected to the frame 202 and midpoint position of the top of the nozzle assembly 104 within the frame 202 shows that the nozzle assembly 104 is at about the midpoint of its allowable vertical range of motion within the field device 100. In FIG. 6c the ski/translation device 206 of the nozzle assembly 104 is stretching down to contact the ground and/or are not in contact with the ground, the parallel linkage arms 222 are angled downward and the nozzle assembly 104 is slid partially down within the frame 202 such that it's top most point is visible through a portion of the frame 202, indicating that the nozzle assembly 104 is at about the midpoint of its allowable vertical range of motion within the field device 100.

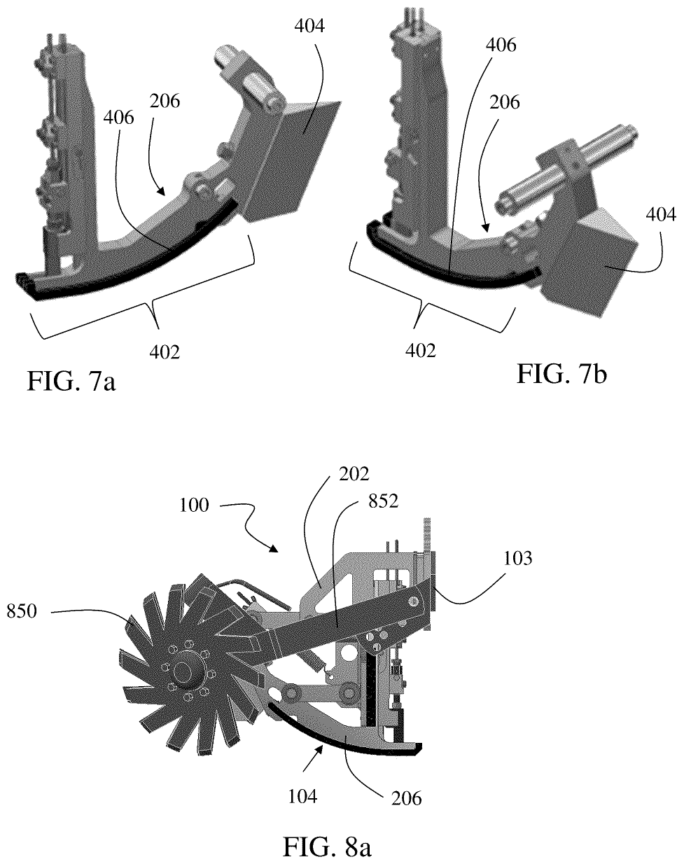

FIGS. 7a and 7b show various perspective views of a portion of the nozzle assembly 104 of FIG. 2, including an exemplary configuration of the ground translation device 206 of the nozzle assembly 104, according to some embodiments of the present invention. As shown, the ground translation device 206 includes a bottom curved portion 402 having a curved surface designed to glide over the surface of the ground to ensure smooth traversal and provide guidance during traversal. In addition, the curved portion 402 of the ground translation device 206 can exert a downward force on the ground to directly compress the unwanted ground surface material beneath during traversal. As described above, the downward force exerted by the ground translation device 206 can be independent from and much smaller than the downward force exerted by the agricultural implement 103 to which the nozzle assembly 104 is attached. The ground translation device 206 can also include a brush buster 404 connected to at least one of the tuning unit (e.g., one or more of the link arms 222) or the frame 202 and positioned proximal to the cutting head 208 along the longitudinal axis 108. The brush buster 404 is configured to physically push any unwanted ground surface material away from the path of travel.

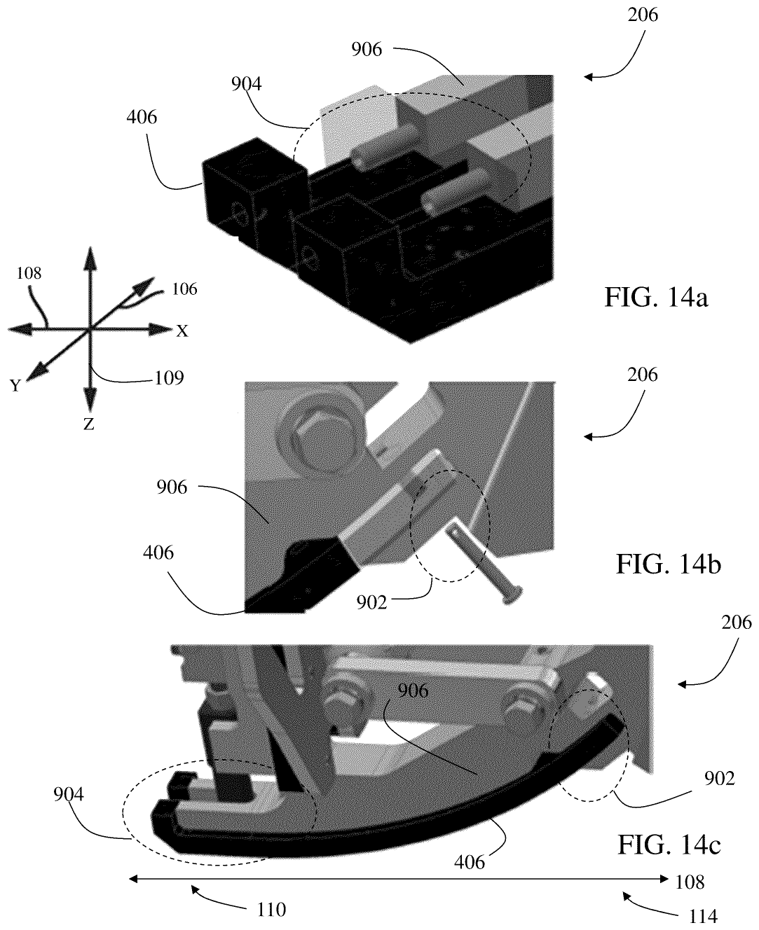

In some embodiments, at least one of the curved portion 402 or the brush buster 404 is formed from one or more non-incendive materials (e.g., hard plastics) and/or is partially enclosed by a non-incendive material. In some embodiments, as illustrated in FIGS. 7a and 7b, at least one of the curved portion 402 or the brush buster 404 is attached to a wear strip 406 forming a skin or cover constructed from one or more non-incendive materials. The wear strip 406 is configured to cover and shield exposed surfaces of the ground translation device 206 (hereinafter referred to as “contact surfaces”) that can potentially contact the ground and/or unwanted ground surface materials during operation. Thus, the nozzle assembly 104 may only contact the soil/ground via the non-incendive material of the wear strip 406. In addition, the wear strip 406 can be coupled to a quick-change, no-tool mounting feature (as described below with reference to FIGS. 14a-c), enabling its easy replacement when worn.

These non-incendive materials have low-friction properties and can comprise non-ferrous metals, ceramics, low-friction plastics (e.g., silicon, polytetrafluoroethylene (PTFE), ultra-high molecular weight polyethylene (UHMWPE), polyetheretherketone (PEEK), nylon, acetal (Polyoxymethylene, POM), phenolics, composite materials), etc. In some embodiments, a non-incendive material is a composite material combining, for example, two or more of carbon fiber, graphite, and PTFE, which can offer a balance of low friction, high strength, and resistance to wear and heat. Using one or more non-incendive materials for forming and/or covering one or more portions of the ground translation device 206 is adapted to promote smooth travel over a ground surface by minimizing direct contact with and drag from the unwanted ground surface material, thereby preventing sparking and/or friction build-up, especially when coming into contact with hard substances such as rocks or metals. This can prevent accidental fire, improve operational safety, lower maintenance costs and extend the lifespan of the ground translation device 206. In alternative embodiments, the ground translation device 206 and/or the wear strip 406 is composed of a metallic material, such as a low spark metal (e.g., stainless steel). In some embodiments, the nozzle assembly 104 includes a low-pressure spray feature (not shown) configured to periodically coat/cool the contact surfaces of the curved portion 402 and/or the brush buster 404 with water and/or a lubricant (e.g., soap).

Furthermore, the nozzle assembly 104 can include one or more additional components to assist in planting or other agricultural processes. In some embodiments, the nozzle assembly 104 includes a ground safety switch (not shown) configured to activate at least one of the cutting head 208 or the secondary nozzle 216 when a load is detected on the ground translation device 206. In some embodiments, the ground safety switch is a pressure switch configured to only permit the cutting head 208 and/or the input nozzle 216 to fire when there is detection of pushback pressure from the ground on the switch.

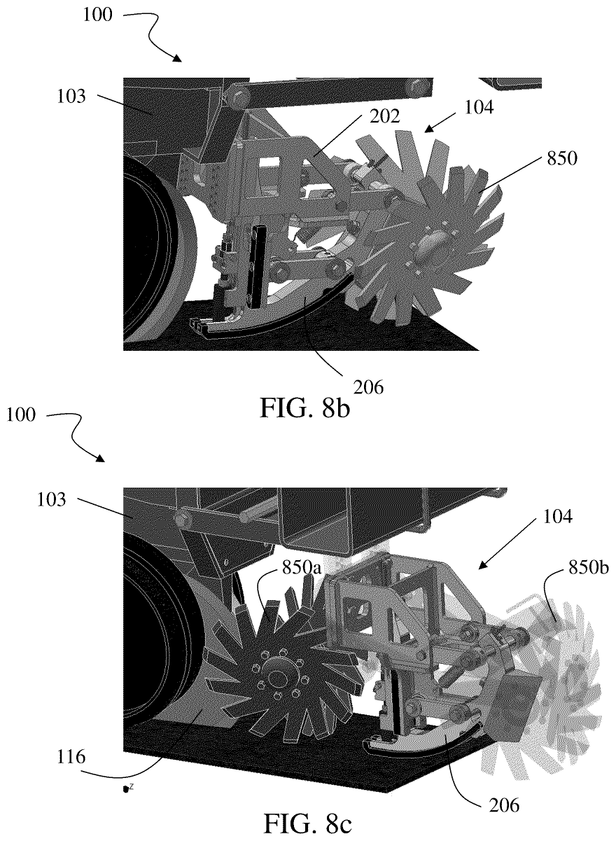

In some embodiments, the nozzle assembly 104 includes one or more row cleaners configured to physically sweep any unwanted ground surface material away from the path of travel without cutting through the unwanted ground surface material. FIGS. 8a-c show various configurations of the field device 100 incorporating the nozzle assembly 104 of FIGS. 2-3b and one or more row cleaner assemblies 850 comprising one or more row cleaners, according to some embodiments of the present invention. In FIG. 8a, a row cleaner assembly 850 is attached to the frame of the agricultural implement 103 via a dedicated linkage arm 852 that is distinct from the link arms 202 of the nozzle assembly 104. The row cleaner assembly 850 can be positioned adjacent to the proximal end of the ground translation device 206 of the nozzle assembly 104, with one row cleaner on each side of the ground translation device 206 to follow ground contours, as shown in FIG. 8a. Alternatively, as shown in FIG. 8b, a row cleaner assembly 850 can be directly mounted onto the ground translation device 206 with one row cleaner on each side of the ground translation device 206. In the embodiment of FIG. 8b, the pair of row cleaners 850 are connected to the link arms 222 of the nozzle assembly 104 and move substantially in unison with the ground translation device 206 of the nozzle assembly 104. In yet another embodiment, as shown in FIG. 8c, multiple row cleaner assemblies 850a, b are attached to the agricultural implement 103 with one row cleaning assembly 850a positioned between the rigid soil conditioner 116 (e.g., a disc opener) and the nozzle assembly 104 and another row cleaning assembly 850b positioned adjacent to the ground translation device 206 in a manner similar to the embodiment of the FIG. 8a or 8b. The post-jet, pre-disc row cleaning assembly 850a can be connected via a rigid support and/or a linkage arm (not shown) and is configured to operate on any unwanted ground surface material that has already been cut by the nozzle assembly 104. More specifically, this row cleaning assembly 850a can separate pre-sliced unwanted ground surface material before the disc opener 116 engages. The proximal row assembly 850b may or may not be present/utilized.

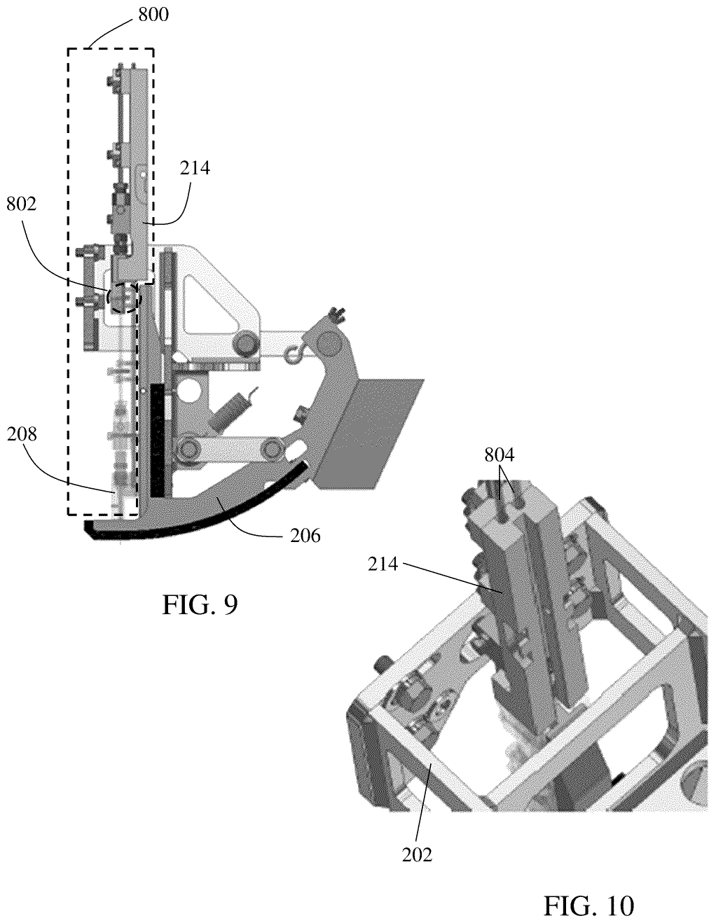

In another aspect, the nozzle assembly 104 includes quick disconnect features to facilitate installation and removal of one or more components of the nozzle assembly 104 for easy maintenance and/or replacement. In general, these quick-disconnect features facilitate component replacement or servicing, reduce downtime and improve efficiency of maintenance processes. FIG. 9 shows a sub-assembly 800 of the nozzle assembly 104 of FIG. 2 comprising the quick-disconnect post 214 and the cutting head 208 of the nozzle assembly 104 that can be easily removed from the nozzle assembly 104 as a single unit, according to some embodiments of the present invention. FIG. 10 shows a portion of the nozzle assembly 104 of FIG. 2 from which the sub-assembly 800 of FIG. 9 is removed, according to some embodiments of the present invention.

As shown in FIG. 9, removal of one or more pins 802 in the nozzle assembly 104 can quickly disengage a sub-assembly 800 comprising the quick-disconnect post 214 and the cutting head 208 bolted thereto from remaining components in the nozzle assembly 104, including the ground translation device 206. More specifically, during disassembly, once the pins 802 are removed, an operator can pull the sub-assembly 800 by the quick-disconnect post 214 vertically upward from a carriage formed by the frame 202 of the nozzle assembly 104, as shown in FIG. 10. This allows maintenance access (e.g., to a technician in the field) to previously shielded or difficult to reach elements, such as the cutting head 208 of the sub-assembly 800 after it is pulled from the frame 202. Thus, the quick-disconnect post 214 not only allows the cutting head 208 to move vertically in unison with the ground translation device 206 during operation to adapt to ground variations, but also enables easy removal of the cutting head 208 from the nozzle assembly 104. This disassembly approach using the quick-disconnect post 214 improves components access and handling in the field as well as facilitates periodic cutting head servicing at a more convenient location while keeping ultra-high pressure plumbing 804 supplied to the cutting head 208 intact to reduce potential risk of contamination during servicing.

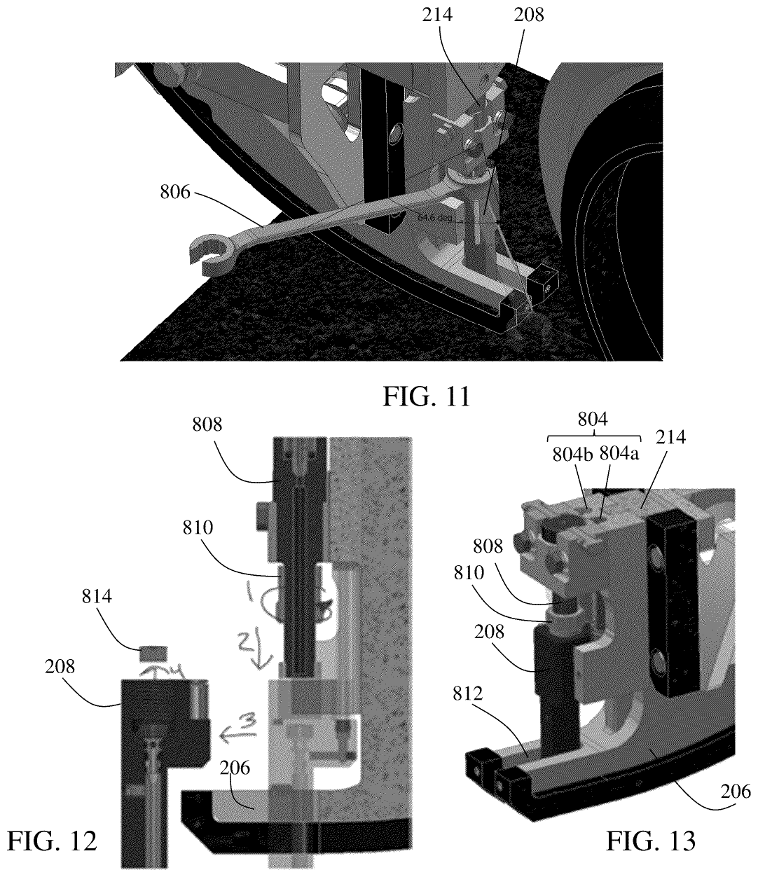

FIGS. 11 and 12 illustrate another approach for quickly removing the cutting head 208 from the nozzle assembly 104 of FIG. 2, according to some embodiments of the present invention. FIG. 13 shows a detailed view of an exemplary connection of the cutting head 208 to the nozzle assembly 104 prior to its removal using the approach of FIGS. 11 and 12, according to some embodiments of the present invention. As shown in FIG. 13, the cutting head 208 is connected to the quick-disconnect post 214 of the nozzle assembly 104 via an adapter 808, which is in turn bolted to the cutting head 208 via a gland nut 810. In operation, the combination of the adapter 808 and the gland nut 810 transforms a supply of high-pressure water into a high-pressure liquid jet for dispensing by the cutting head 208. Furthermore, as explained above, several input lines 804 can be supplied to the cutting head 208 in addition to the main high-pressure water supply. For example, there can be two input lines 804 for supply into a combined output line (not shown) in a Y-configuration, and the combined output line is adapted to directly feed into an input port of the cutting head 208. One input line 804a is adapted to supply fresh atmospheric air (e.g., filtered clean air) and the other input line 804b is adapted to supply agricultural input. In some embodiments, the input line 804b is configured to receive a metered amount of agricultural input (e.g., via a set PSI through a set sized orifice) that is positively forced into the Y-configuration, and any vacuum in the combined output line is vented to prevent any negative effects from the metering. In some embodiments, the tubing for the input line 804a has a larger diameter than the tubing for the input line 804b to ensure that the venturi vacuum effect of the combined output line does not affect the metering setup at the input line 804b, such that a proper amount of the agricultural input can be fed from input line 804b. In some embodiments, the combined output line provides a vented, metered agricultural liquid to the cutting head 208.

As shown in FIGS. 11 and 12, to disassemble the cutting head 208 from the nozzle assembly 104 while the quick-connect post 214 is still connected within the nozzle assembly 104, as the first step an operator can use a wrench 806 to loosen the gland nut 810 connecting the cutting head 208 to the adapter 808, such as rotating the nut 810 by about 64 degrees. As the second step, once the gland nut 810 is loosen, the operator can force the cutting head 208 downward until it is free from the adapter 808. As the third step, the operator can slide the cutting head 208 laterally from a slot 812 within the ground translation device 206 until the cutting head 208 is clear of the ground translation device 206. As the fourth step, the operator can then service one or more components of the cutting head 208, such as removing an orifice 814 of the cutting head 208. As an optional step, the operator can further disconnect the input lines 804 from the cutting head 208 to completely severe the cutting head 208 from the nozzle assembly 104 and the agricultural implement 103.

In some embodiments, the nozzle assembly 104 further includes one or more quick-disconnect features for replacing the wear strip 406 of the ground translation device 206. FIGS. 14a-c show a series of steps in an exemplary approach for installing the wear strip 406 onto a bracket 906 of the ground translation device 206 of the nozzle assembly 104 of FIG. 2, according to some embodiments of the present invention. In general, a set of engagement features can be employed for the installation, including one or more latches, pins, and/or screws configured to fixedly attach the wear strip 406 to the metal bracket 906 of the ground translation device 206. As shown, two attachment features 902, 904 can be used to secure the wear strip 406 to the bracket 906. The frontend attachment feature 902 is located on the proximal end 114 along the longitudinal axis 108 (i.e., the direction of travel) at the forward-facing surface of the ground translation device 206. The backend attachment feature 904 is located on the distal end 110 along the longitudinal axis 108 at the back of the ground translation device 206, substantially opposite of the front-end attachment feature 902 along the longitudinal axis 108. In some embodiments, the attachment features 902, 904 are disposed substantially in line with the direction of travel of the ground translation device 206 relative to the ground, thereby securing the wear strip 406 to the ground translation device 206 and preventing its separation from the ground translation device 206. In some embodiments, these attachment features 902, 904 are disposed substantially above the bottom most plane of the ground translation device 206 (e.g., above the contact surface, recessed from the ground, etc.) such that these features are prevented from having any contact with the ground during operation, even as the wear strip 406 wears down. For example, these attachment features 902, 904 can be located on surfaces that are substantially normal to the plane of the bottom of the ground translation device 206 and/or the direction of travel. As shown in FIG. 14a, the back-end attachment feature 904 includes a connection mechanism (e.g., a latch, hairpin, quick release pin, cotter key, etc.), such as a latch style connection mechanism as illustrated. As shown in FIG. 14b, the front-end attachment feature 902 includes a pin configuration. During installation, the pivoting allowed by the latch style connection mechanism 904 facilitates quick and easy installation of the wear strip 406 in a field by laterally sliding the wear strip 406 into position on the bracket 906 at the distal end 110 (as shown in FIG. 14a). Then, the opposite, proximal end 114 of the wear strip 406 is pivoted into the frontend connection mechanism 902 in the form of the pin configuration for securement of the wear strip 406 to the bracket 906 at the proximal end 114 (as shown in FIG. 14b). FIG. 14c shows the completed assembly of the ground translation device 206 comprising the wear strip 406 secured to the bracket 906.

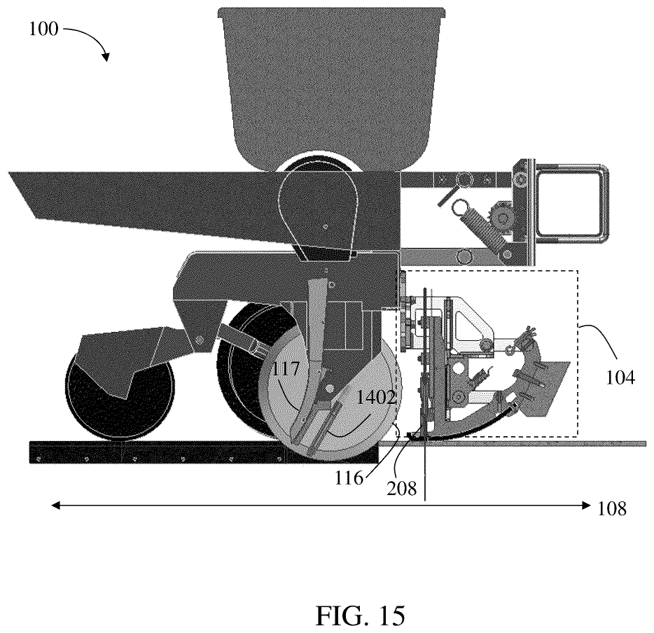

It should be understood that various aspects and embodiments of the invention can be combined in various ways. Based on the teachings of this specification, a person of ordinary skill in the art can readily determine how to combine these various embodiments. Modifications may also occur to those skilled in the art upon reading the specification. For example, in addition to the nozzle(s) in the nozzle assembly 104, the field device 100 can also include one or more nozzles disposed on the row unit. FIG. 15 shows an exemplary configuration of the field device 100 of FIG. 1 with an additional nozzle 1402 located outside of the nozzle assembly 104 of FIGS. 2-3b, according to some embodiments of the present invention. The nozzle assembly 104 can be a retrofit unit added onto an existing planter. The additional nozzle 1402 is located such that it operates post/after ground trench formation by the combination of the rigid soil conditioner (e.g., a physical opening device) 116 and the cutting head 208 of the nozzle assembly 104, but before seed placement by the seeding device 117. As shown in FIG. 15, this operational order can be achieved by locating the additional nozzle 1402 between the seeding device 117 and the nozzle assembly 104 along the longitudinal axis 108. The additional nozzle 1402 can be configured to apply an input after trench formation and prior to seed injection. This configuration thus minimizes the smearing risk from the added liquid volume, back to only the moisture introduced from the ultra-high-pressure jet of the cutting head 208 at the proximal end 114 of the field implement 103. In some embodiments, the additional nozzle 1402 is configured to deliver an ultra-high-pressure liquid jet (e.g., about 60,000 PSI) if not much volume is required. In some embodiments, the additional nozzle 1402 is configured to deliver a low-pressure liquid jet (e.g., about 1,000 to about 5,000 PSI). In some embodiments, the field device 100 includes yet another nozzle (not shown) outside of the nozzle assembly 104, which can be combined with the additional nozzle 1402 to form a high-pressure leading and low-pressure trailing pair. Both nozzles can contact the soil post trench formation by the rigid soil conditioner 116 and prior to seed injection by the seeding device 117. In some embodiments, the input applied by the post-opening, pre-seeding nozzle(s), such as additional nozzle 1402, is unrelated to seeding. In some embodiments, the exit of each post-opening, pre-seeding nozzle(s) is above or below soil level. In applications where residue/planting ability is deemed a non-concern, the post-opening, pre-seeding nozzle(s) can be the only nozzle(s) present, with the nozzle assembly 104 not attached or utilized.

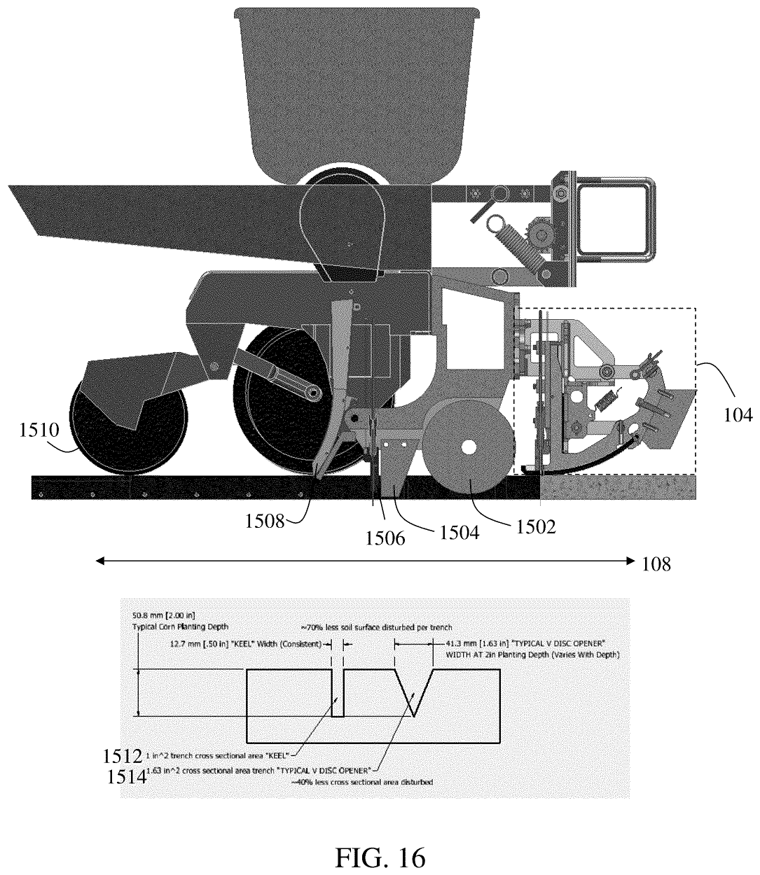

FIG. 16 shows another exemplary configuration of the field device 100 of FIG. 1 incorporating the nozzle assembly 104 of FIGS. 2-3b, according to some embodiments of the present invention. Similar to the field device of FIG. 15, the nozzle assembly 104 can be a retrofit unit added onto an existing planter. As shown, along the longitudinal axis 108 which indicates the direction of travel of the field device 100, the nozzle assembly 104 (including the cutting head 208) is followed by a qualifying disc 1502, a keel 1504, a high-pressure nozzle 1506, a seeding device 1508 and a firmer 1510. The qualifying disc 1502 is configured to cut through any residue that the cutting head 208 of the nozzle assembly 104 cannot. The keel 1504 is configured to open the trench generated from the combination of the cutting head 208 and the qualifying disc 1502 (e.g., wider than the width of a seed) in preparation for subsequent seed plantation. The additional high-pressure nozzle 1506 is configured to cut the trench again, but below the ground level. Subsequently, seed placement into the trench is performed by the seeding device 1508. This can be followed by the firmer 1510 and/or deposition of a fertilizer input, followed by a closer (not shown) to close the seeded trench. The benefit of using the additional nozzle 1506 after the ground is opened by the nozzle assembly 104, but before seeds are placed by the seeding device 1508, is that the cut is not being collapsed by another mechanical item and the resulting slit is adapted to provide an easy path for rooting of the subsequently deposited seeds. The benefit of using the keel 1504 in comparison to a traditional disc opener is that the substantially rectangular-shaped trench 1512 created by the keel 1504 is thinner and narrower and easier to close than the V-shaped trench 1514 created by a traditional disc opener.

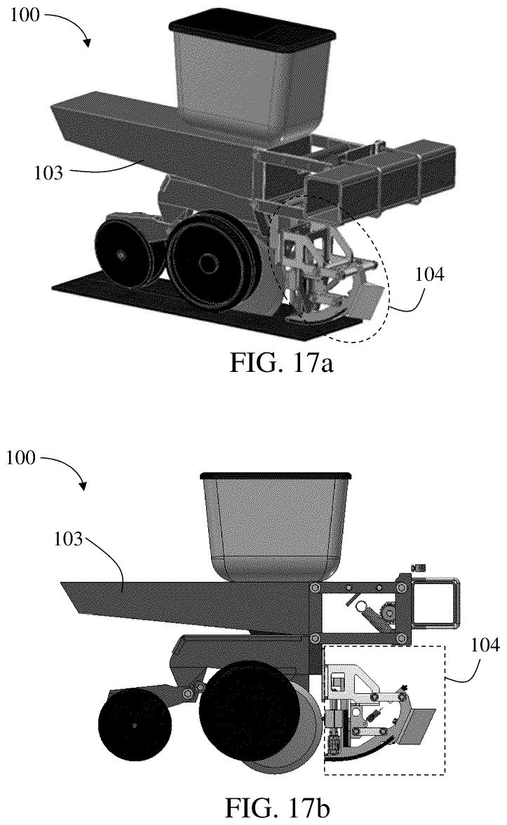

FIGS. 17a and 17b show perspective and side views, respectively, of another exemplary configuration of the field device 100 comprising the nozzle assembly 104 of FIGS. 2-3b and the agricultural implement 103 in the form of a traditional mechanical planter, according to some embodiments of the present invention. In this configuration, the nozzle assembly 104 is retrofitted to become operationally compatible with an existing planter 103, which can have one or more components described above with reference to FIG. 1. As explained above with reference to FIGS. 2-3b, the interface 220 of the nozzle assembly 104, including the multiple rows of bolt holes 221, can enable easy attachment and disengagement of the nozzle assembly 104 relative to the mechanical planter 103. Thus, a fluid jet system can be retrofitted to and combined with traditional mechanical planting means to significantly improve the planting process. The retrofit unit (i.e., the nozzle assembly 104) can introduce multiple benefits over traditional seed planting equipment, including providing a cost-effective solution for farmers who would like to upgrade their equipment without purchasing entirely new machinery. In addition, the retrofit unit can improve operational efficiency and safety and enhance crop yield and soil health while making fluid jet cutting systems reliable, accurate, and serviceable enough to be employed in a dynamic external environment.

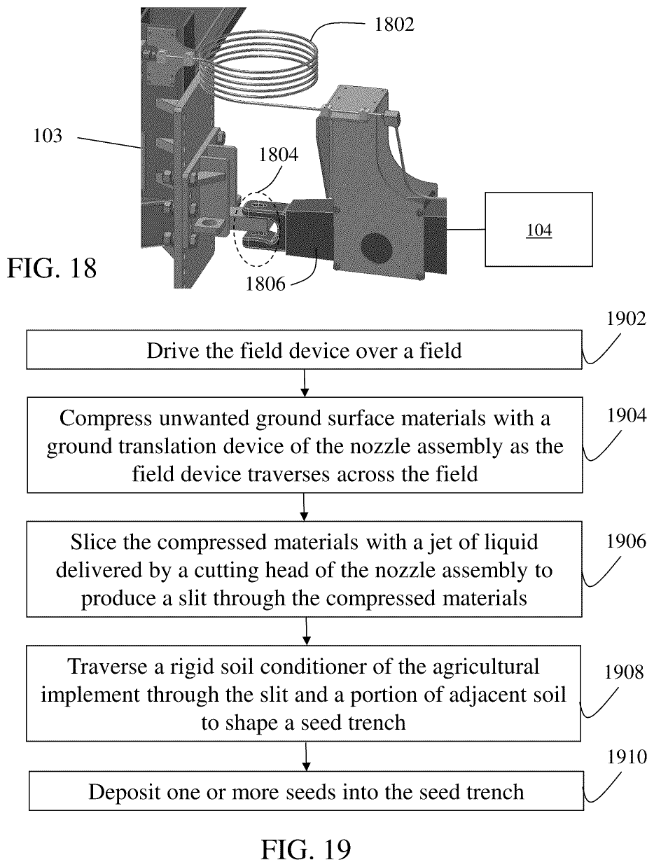

FIG. 18 shows a perspective view of yet another exemplary configuration of the field device 100 comprising the nozzle assembly 104 of FIGS. 2-3b connected to the agricultural implement 103, according to some embodiments of the present invention. As shown, an ultra-high-pressure coiled pipe 1802 (e.g., a ⅜-inch diameter coiled pipe for conducting a liquid of about 60,000 PSI or higher) is provided. The coiled pipe 1802 can be disposed across a pivot point 1804, which serves as a dynamic connection between the agricultural implement 103 and a tongue 1806 that connects to the nozzle assembly 104. The coiled pipe 1802 facilitates transfer of ultra-high pressure across the pivot point 1804. The coiled pipe diameter of about ⅜ inches is adapted to provide scalability so that any pressure loss can be satisfactory. In contrast, on a 24-row planter, a ¼-in coiled pipe, which is the industry standard, is adapted to generate too large of a pressure drop over coil length.

FIG. 19 shows an exemplary process 1900 for utilizing the field device 100 of FIG. 1 to seed a field, according to some embodiments of the present invention. At step 1902, the field device 100 is driven across the field, such as by the mobile device 112. At step 1904, as the field device 100 traverses across the field, the ground translation device 206 of the nozzle assembly 104 of the field device 100 compresses any unwanted ground surface materials. Drag generated from the unwanted ground surface materials can be minimized during compression due to the translation device 206 being covered by a ground contact attachment, such as the wear strip 406, made from a non-incendive material. At step 1906, the cutting head 208 of the nozzle assembly 104 is configured to eject a liquid jet to slice the compressed material to generate a slit through the soil underneath the compressed material. In some embodiments, the jet of liquid is pressurized to over 10,000 PSI (e.g., about 60,000 PSI) by the liquid jet soil processing system 102 prior to being ejected by the cutting head 208. In some embodiments, the slicing of the compressed material by the cutting head 208 occurs at the apex 210 of the curved portion of the ground translation device 206. More specifically, the liquid jet introduced by the cutting head 208 is adapted to intersect the ground at the apex 210 of the ground translation device 206. In some embodiments, the cutting head 208 is only activated if a load at the ground translation device 206 is detected, which signals the presence of a pushback pressure by the ground.

At step 1908, the rigid soil conditioner (e.g., a disc opener) 116, which may be coupled to and a part of the agricultural implement 103, traverses through the slit and a portion of adjacent soil to shape the slit to form a seed trench. At step 1910, the seeding device 117, which may also be coupled to and a part of the agricultural implement 103, deposits one or more seeds into the resulting seed trench.

In some embodiments, the ground translation device 206 of the nozzle assembly 104 exerts a downward force on the field as it compresses the unwanted ground surface materials at step 1904. This downward force is smaller than a downward force created by the rigid soil conditioner 116 as it traverses the same field to create the seed trench at step 1908. In some embodiments, the ground translation device 206 is connected to the agricultural implement 103 via a linkage system (e.g., frame 202) that is dynamically independent along the vertical axis 109 from the linkage system that couples the mobile device 112 to the agricultural implement 103. In such a configuration, the vertical movements of the mobile device 112, the agricultural implement 103 (including the rigid soil conditioner 116), and the ground translation device 206 are relatively independent from one another as the field device 100 traverses the terrain.

In some embodiments, the tuning unit of the nozzle assembly 104, which includes the link arms 222 and the precision guide 218, is configured to guide the cutting head 208 and the ground translation device 206 to move along the vertical axis 109 substantially perpendicular to the surface of the field below the nozzle assembly 104, while preventing the nozzle assembly 104 from swaying laterally, as the field device 100 traverses across the field. The tuning unit can also ensure that the cutting head 208 is aligned along the centerline 226 of the nozzle assembly 104, which can further align with the rigid soil conditioner 116 to ensure that they have overlapping paths.

In some embodiments, the brush buster 404 of the nozzle assembly 104, which is positioned at the proximal tip of the ground translation device 206, brushes at least a portion of the unwanted ground surface materials from the travel path prior to the ground translation device 206 compressing the unwanted ground surface materials at step 1904. In some embodiments, the secondary nozzle 216 of the nozzle assembly 104, which is positioned distal to the cutting head 208 and proximal to the rigid soil conditioner 116, injects an agricultural input, such as a fertilizer, into the slit formed by the cutting head 208 at step 1906. This can be prior to the rigid soil conditioner 116 creating a seed trench from the slit at step 1908.

It should be understood that various aspects and embodiments of the invention can be combined in various ways. Based on the teachings of this specification, a person of ordinary skill in the art can readily determine how to combine these various embodiments. Modifications may also occur to those skilled in the art upon reading the specification.

What is claimed is:

1. A nozzle assembly attached to an agricultural implement comprising a liquid jet soil processing system, the nozzle assembly comprising:
a frame configured to detachably mount to the agricultural implement;
a cutting head connected to the frame, the cutting head configured to introduce a liquid jet, received from the liquid jet soil processing system, to a field surface below the cutting head;
a secondary nozzle connected to the frame and disposed distal to the cutting head relative to a direction of travel of the nozzle assembly;
a ground translation device connected to the frame, the ground translation device shaped to physically contact the field as the agricultural implement travels across the field; and
a tuning unit dynamically connects the cutting head, the secondary nozzle and the ground translation device to the frame, the tuning unit configured to maintain the cutting head substantially perpendicular to the field surface along a vertical axis as the ground translation device travels across the field.

2. The nozzle assembly of claim 1, wherein the agricultural implement, including a rigid soil conditioner, is configured to exert a first downward force on the field along the vertical axis, and wherein the ground translation device of the nozzle assembly is adapted to exert a second downward force on the field along the vertical axis, wherein the first and second downward forces are different.

3. The nozzle assembly of claim 2, wherein the first downward force is greater than then second downward force.

4. The nozzle assembly of claim 1, wherein the agricultural implement is configured to connect to a mobile device via a linkage system that is dynamically independent, along the vertical axis, from to the frame that links that nozzle assembly to the agricultural implement.

5. The nozzle assembly of claim 1, wherein the tuning unit is configured to enable vertical movement of the cutting head along the vertical axis while inhibiting lateral movement of the cutting head.

6. The nozzle assembly of claim 5, wherein the tuning unit comprises a plurality of parallel link arms configured to connect the cutting head, the secondary nozzle and the ground translation device to the frame, the plurality of parallel link arms promoting the vertical movement while inhibiting the lateral movement of the cutting head.

7. The nozzle assembly of claim 6, wherein the tuning unit further comprises a precision guide disposed about the cutting head and configured to promote the vertical movement while inhibiting the lateral movement of the cutting head.

8. The nozzle assembly of claim 7, wherein the tuning unit is further configured to align the cutting head to a centerline of the nozzle assembly.

9. The nozzle assembly of claim 7, wherein the ground translation device includes a ground contact attachment substantially composed of a non-incendive material.

10. The nozzle assembly of claim 9, wherein the ground translation device has a curved shape that is adapted to exert the second downward force to achieve ground compression as the agricultural implement travels across the field.

11. The nozzle assembly of claim 10, further comprising a detachable post slideably located within a channel of the precision guide, wherein the detachable post is connected to the cutting head to locate the cutting head at an apex of the curved shape of the ground translation device.

12. The nozzle assembly of claim 11, wherein the precision guide, via the detachable post, enables the vertical movement of the cutting head along the vertical axis while inhibiting the lateral movement of the cutting head.

13. The nozzle assembly of claim 1, wherein the secondary nozzle is configured to deliver a secondary fluid with a pressure of between about 1000 pounds per square inch (PSI) and 5000 PSI.

14. The nozzle assembly of claim 1, further comprising a brush buster connected to at least one of the tuning unit or the frame, the brush buster disposed proximal to the cutting head relative to the direction of travel of the nozzle assembly.

15. The nozzle assembly of claim 1, further comprising a set of high-pressure line connectors configured to connect to respective ones of a set of high-pressure lines from the liquid jet soil processing system to receive the liquid jet.

16. The nozzle assembly of claim 1, further comprising a ground safety switch configured to activate the cutting nozzle and the secondary nozzle only when a load is detected on the translation device.

17. The nozzle assembly of claim 1, wherein at least one of the cutting head or the secondary nozzle is connected to an input system of the liquid jet soil processing system for receiving and injecting at least one agricultural input.

18. The nozzle assembly of claim 4, further comprising a transmission system operably connected to a pump of the liquid jet soil processing system, the transmission system configured to increase the speed of a power unit received from the mobile device.

19. A method of seeding a field with a field device comprising a liquid jet soil processing system, the method comprising:
driving the field device over a field, the field device comprising a nozzle assembly detachably connected to an agricultural implement incorporating the liquid jet soil processing system;
compressing unwanted ground surface materials with a ground translation device of the nozzle assembly as the field device traverses across the field;
slicing the compressed materials with a jet of liquid delivered by a cutting head of the nozzle assembly to produce a slit through the compressed materials, wherein the jet of liquid is pressurized to over 10,000 PSI by the liquid jet soil processing system;
traversing a rigid soil conditioner of the agricultural implement through the slit and a portion of adjacent soil to shape a seed trench; and
depositing one or more seeds into the seed trench.

20. The method of claim 19, wherein the ground translation device of the nozzle assembly produces a first downward vertical force on the unwanted ground surface materials and the rigid soil conditioner produces a second downward vertical force on the portion of soil below the compressed materials.

21. The method of claim 20, wherein the second downward force is greater than the first downward force.

22. The method of claim 20, wherein the ground translation device has a curved shape and the cutting head is located at an apex of the curved ground translation device.

23. The method of claim 22, wherein the slicing of the compressed material by the cutting head occurs at the apex of the curved ground translation device.

24. The method of claim 19, further comprising:
connecting the ground translation device of the nozzle assembly to the agricultural implement, including the liquid jet soil processing system and the rigid soil conditioner, via a first linkage; and
connecting a mobile device to the agricultural implement via a second linkage, wherein
the first and second linkages are dynamically independent from each other along a vertical axis.

25. The method of claim 19, further comprising aligning and maintaining the cutting head and the rigid soil conditioner along a centerline of field device.

26. The method of claim 19, further comprising guiding the nozzle assembly, including the cutting head and the ground translation device, to move along a vertical axis substantially perpendicular to a surface of the field below the nozzle assembly, while preventing the nozzle assembly from moving laterally.

27. The method of claim 19, further comprising injecting, by a secondary nozzle of the nozzle assembly, an agricultural input into the slit formed by the cutting head, wherein the injecting of the agricultural input is prior to shaping the seed trench by the rigid soil conditioner.

28. The method of claim 19, further comprising brushing at least a portion of the unwanted ground surface materials from a travel path by a brush buster coupled to the ground translation device prior to the compressing and slicing.

29. The method of claim 28, further comprising minimizing drag from the unwanted ground surface materials via a ground contact attachment coupled to at least one of the translation device or the brush buster, wherein the ground contact attachment is made from a non-incendive material.

30. The method of claim 19, further comprising activating the slicing by the jet of liquid only when a load is detected on the ground translation device.
